(19) United States
(12) Patent Application Publication
(10) Pub. No.: US 2009/0154726 A1
(43) Pub. Date: Jun. 18, 2009

(54) System and Method for Noise Activity Detection

(75) Inventor: Jon C. Taenzer, Los Altos, CA (US)

Correspondence Address: Nixon Peabody LLP, 200 Page Mill Road, Palo Alto, CA, 94306, US

(73) Assignee: STEP LABS INC., San Jose, CA (US)

(21) Appl. No.: 12/196,274

(22) Filed: Aug. 21, 2008

Related U.S. Application Data
(60) Provisional application No. 60/965,854, filed on Aug. 22, 2007.

(51) Int. Cl. H04B 15/00

(52) U.S. Cl. 381/94.1

(57) ABSTRACT

A noise activity detector includes a circuit for calculating average energy in a critical bandwidth, a circuit for determining a threshold function, a circuit for generating a dynamic modification of the threshold function, a circuit for identifying frequency components of the signal having energy that is above threshold values determined by the threshold function, and to determine a first average energy value representing an average energy of the identified frequency components with energy above the threshold, a circuit for identifying frequency components of the signal having energy that is below threshold values determined by the threshold function, and to determine a second average energy value representing an average energy of the identified frequency components with energy below the threshold, a circuit for offsetting at least one of the first and second average energy values, a circuit for comparing the resultant average energy values with one another, and a circuit for indicating the presence of noise activity if the first average energy value is below the second average energy value.

### CROSS REFERENCE TO RELATED APPLICATIONS

This application claims the benefit of U.S. Provisional Patent Application No. 60/965,854, filed on Aug. 22, 2007, entitled “Noise Detector”, the disclosure of which is hereby incorporated by reference for all purposes.

### TECHNICAL FIELD

The present disclosure relates generally to noise activity detectors for use in for example noise reduction systems.

### BACKGROUND

In many signal processing applications, such as echo cancellation, speech recognition, speech encoding, voice-over-IP, and in particular noise reduction systems, it is important to gather real-time information and statistics about the noise in the signal. This is most often achieved by detecting when there is a useful amount of the desired signal and treating that portion of the signal as “non-noise.” At other times, the signal is assumed to be only noise and the information and statistics that are desired are gathered during those times.

In single channel systems, the noise and desired signal are mixed, and the incoming mixed noisy signal is considered to be a linear sum of the desired signal and unwanted noise. By detecting when there is the presence of desired signal in the mixed signal, the noise information is not updated during this part of the signal. Instead, updating of the noise characteristics at other times allows noise reduction, for example, to be executed with appropriate processing.

In voice communication systems, the need for determining the presence of noise-only periods has given rise to the proliferation of numerous voice determination methods, often called voice detection or voice activity detection (VAD) methods, since the voice portion of the mixed signal is the desired portion.

Such methods usually rely upon the fact that talkers must hear at least a portion of their own voice in order to form their words properly. In order to reliably hear themselves speak, talkers need to keep their own voice about 10 dB above the ambient or background noise level. Thus, in the presence of loud background noise, talkers naturally elevate their voice level to keep it slightly above the competing background noise level.

Voice activity detection methods, whether implemented in the time domain or in the frequency domain, utilize this fact. Many such systems are based upon means that detect when the total energy of the incoming noisy signal is above a threshold, and indicate that there is the presence of voice when this condition is met. Of course, the threshold must be adjusted to be always above the level of the background noise portion of the signal but below the level of the combined voice-plus noise level. Many complex methods have been devised to create such real-time dynamic threshold adjustment for this purpose.

However, such “reverse” methods—that is the detection of the desired signal so that the noise periods can be implied, rather than the direct detection of the noise portions themselves, have drawbacks. For example, in noise above approximately 90 dB SPL (Sound Pressure Level) it becomes nearly impossible for humans to further elevate the loudness of their voice and the SNR (signal-to-noise ratio) of the input signal drops, often to below 0 dB (1:1).

Conventional voice detection systems operate poorly, or not at all, when the SNR becomes low—for example below 10 dB. As long as the voice signal power is significantly above the noise signal power, such systems are able to detect the presence of voice. But in increasingly noisy situations, the voice detection accuracy decreases until such systems fail to operate at all.

Another significant problem is the detection of wind noise, the noise created when air flows over microphones used in voice detection systems. With the proliferation of mobile communication devices, wind noise is becoming of critical importance. Such noise can exhibit highly variable properties, and therefore the noise of wind is often misclassified by such systems. When this happens, the noise reduction of VAD-based noise reduction systems can be compromised because the noise template is incorrectly updated. For wind noise to be correctly classified, additional methods or processes must be implemented to reliably detect it, at the cost of more complexity and expense.

Yet another difficulty with conventional voice detection schemes is that voice signals do not abruptly terminate but slowly decay after each utterance. Voice detection based upon the voice power being above a noise power threshold will falsely indicate the end of voicing when the voice signal's decaying tail drops below the threshold level, even though voice is still present. Therefore these systems often add a so called “hangover” timer to delay the onset of the noise indication.

Classical voice detection methods assume that the background noise is stationary or only slowly varying. In non-stationary noise conditions, classical voice detection schemes are unreliable, since rapid changes in noise level, especially upward jumps in noise, can not be distinguished from the onset of a voice burst and therefore give false indications of voice presence.

Such voice detectors also react to the presence of nearby voices other than that of the user, even though background voices are actually “noise” in systems where the user's own voice is the only desired signal.

Further, virtually all voice detection methods rely upon setting or updating one or more thresholds based upon the prior history of the signal, rather than on instantaneous current conditions. By relying upon prior information, such thresholds can not update quickly, and the voice detection output is slow to react to rapid changes in background noise, creating errors until the system can eventually adjust.

The problems with voice detection methods historically have been addressed by adding enhancements to the basic principle of signal power threshold detection. Such enhancements include means for tracking noise levels in order for the threshold to be updated in real time, the addition of separate wind detector schemes, improved sensitivity methods allowing the threshold to be set with greater precision to operate in lower SNR conditions, adding hangover methods to prevent the false indication that voicing has ended when at the end of an utterance it has simply decayed below the threshold, and creating lockout periods that wait for a time longer than any expected naturally occurring voicing period after which the threshold is allowed to adjust more rapidly in order to attempt to accommodate bursts or steps in background noise level. However, using such enhancements still produces limited operation and still results in the false detection of noise-only signal conditions.

Yet other voice detection methods have been created that rely upon the availability of more than one signal, such as from an array of sensors or microphones. However, these systems have the great disadvantage that they only work when multiple signals are available, or where multiple sensors can be accommodated. Also, they increase the complexity, cost, size and power consumption of such systems.

Other solutions that are known rely upon complex signal processing computations such as autocorrelation, cross correlation, variance, Linear Predictive Coding (LPC) coefficients, various statistical noise predictors (e.g. Gaussian, Laplacian and Gamma distributions), stationarity measures, and so on. In general these solutions do not significantly improve performance, and are still aimed at the detection of voicing periods rather than detection of the noise-only periods themselves.

### OVERVIEW

As described herein, a method for generating an indication of noise activity in a signal includes:

a) calculating average energy of the signal in a critical bandwidth;

b) determining a frequency-dependent threshold function;

c) generating a dynamic modification of the frequency-dependent threshold function using the average energy;

d) identifying frequency components of the signal having energy that is above threshold values determined by the threshold function at corresponding frequencies, and determining a first average energy value representing an average energy of the identified frequency components with energy above the threshold values;

e) identifying frequency components of the signal having energy that is below threshold values determined by the threshold function at corresponding frequencies, and determining a second average energy value representing an average energy of the identified frequency components with energy below the threshold values;

f) applying an offset value to at least one of the first and second average energy values;

g) comparing, after application of said offset value, the resultant first and second average energy values with one another; and

h) indicating the presence of noise activity if, as a result of said comparison, it is determined that, the resultant first average energy value is below the resultant second average energy value.

Also as described herein, a noise activity detector for generating an indication of noise activity in a signal includes:

a) a first circuit configured to calculate the average energy in a critical bandwidth;

b) a second circuit configured to determine a frequency-dependent threshold function;

c) a third circuit configured to generate a dynamic modification of the frequency-dependent threshold function using the average energy;

d) a fourth circuit configured to identify frequency components of the signal having energy that is above threshold values determined by the threshold function at corresponding frequencies, and to determine a first average energy value representing an average energy of the identified frequency components with energy above the threshold;

e) a fifth circuit configured to identify frequency components of the signal having energy that is below threshold values determined by the threshold function at corresponding frequencies, and to determine a second average energy value representing an average energy of the identified frequency components with energy below the threshold;

f) a sixth circuit configured to apply an offset value to at least one of the first and second average energy values;

g) a seventh circuit configured to compare, after application of said offset value, the resultant first and second average energy values with one another; and

h) an eight circuit configured to indicate the presence of noise activity if, as a result of said comparison, it is determined that the resultant first average energy value is below the resultant second average energy value.

Also as described herein, a noise activity detector for generating an indication of noise activity in a signal includes:

a) means for calculating average energy of the signal in a critical bandwidth;

b) means for determining a frequency-dependent threshold function;

c) means for generating a dynamic modification of the frequency-dependent threshold function using the average energy;

d) means for identifying frequency components of the signal having energy that is above threshold values determined by the threshold function at corresponding frequencies, and

determining a first average energy value representing an average energy of the identified frequency components with energy above the threshold values;

e) means for identifying frequency components of the signal having energy that is below threshold values determined by the threshold function at corresponding frequencies, and determining a second average energy value representing an average energy of the identified frequency components with energy below the threshold values;

f) means for applying an offset value to at least one of the first and second average energy values;

g) means for comparing, after application of said offset value, the resultant first and second average energy values with one another; and

h) means for indicating the presence of noise activity if, as a result of said comparison, it is determined that, the resultant first average energy value is below the resultant second average energy value.

Also as described herein, a program storage device readable by a machine, embodying a program of instructions executable by the machine to perform a method for generating an indication of noise activity in a signal, the method includes:

a) calculating average energy of the signal in a critical bandwidth;

b) determining a frequency-dependent threshold function;

c) generating a dynamic modification of the frequency-dependent threshold function using the average energy;

d) identifying frequency components of the signal having energy that is above threshold values determined by the threshold function at corresponding frequencies, and determining a first average energy value representing an average energy of the identified frequency components with energy above the threshold values;

e) identifying frequency components of the signal having energy that is below threshold values determined by the threshold function at corresponding frequencies, and determining a second average energy value representing an average energy of the identified frequency components with energy below the threshold values;

f) applying an offset value to at least one of the first and second average energy values;

g) comparing, after application of said offset value, the resultant first and second average energy values with one another; and

h) indicating the presence of noise activity if, as a result of said comparison, it is determined that, the resultant first average energy value is below the resultant second average energy value.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIGS. 1-7 are plots of measured data corresponding to different sound conditions, and each include a long-dashed line modeling the curve that represents the noise power, and a short-dashed line representing average power.

FIG. 8 is a block diagram of a typical communication system front end showing the context within which a noise activity detector (NAD) 20 may be used.

FIG. 9 is a flow diagram of various steps or tasks that may be performed by NAD 20.

FIG. 10 is a block diagram of circuits that implement the tasks set forth in the flow diagram of FIG. 9.

FIG. 11 is a plot illustrating the performance of device using NAD 20.

### DESCRIPTION OF EXAMPLE EMBODIMENTS

Example embodiments are described herein in the context of a processor or individual circuits, or a flow diagram of a process that is performed. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used to the extent possible throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with this disclosure, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card, paper tape and the like) and other types of program memory.

The noise detector, also referred to as a noise activity detector (NAD), as disclosed herein is based upon the unique characteristics of noise as differentiated from the characteristics of other signals, in particular the characteristics of desired signals. Generally, it is applicable to the detection of periods when a signal is only noise, and is especially useful therefore in systems, such as noise reduction systems, where knowledge of noise-only periods is needed for their function. In particular, the arrangement disclosed herein is directed at reliable detection of periods with only acoustic noise in a mixed microphone input signal which may contain speech, wind and acoustic background noise. An alternate use is as a voice activity detector. More particularly, it is directed to use in voice grade communication systems and devices such as cellular telephones, Bluetooth® wireless headsets, voice command and control and automatic speech recognition, among others. For purposes of this discussion, three types of sound are identified: acoustic noise, wind noise, and voice.

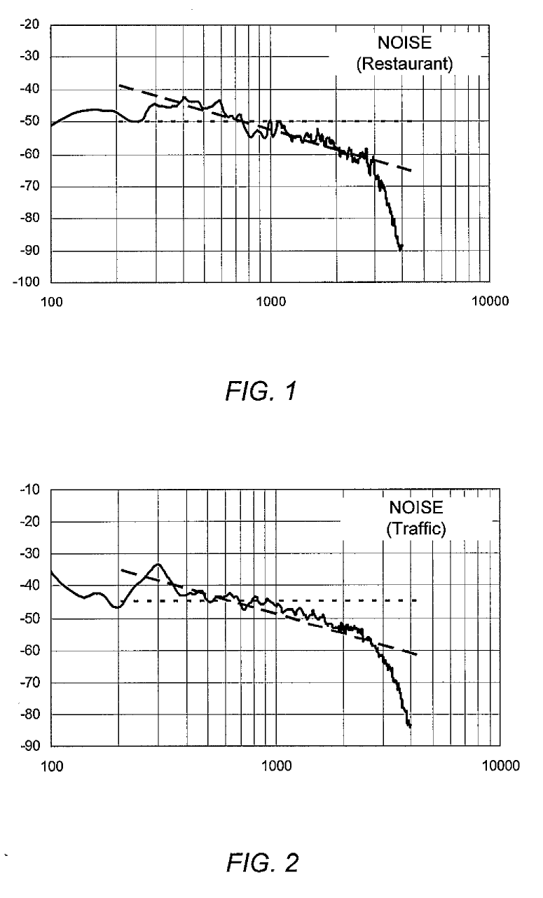

FIG. 1 is a plot of measured data for ambient background noise generated by a multitude of human voices in a crowded restaurant, plotted as the measured signal power in decibels (dB) verses frequency in Hertz (Hz). Considering the frequency band of interest corresponding to the human voice communications band of about 300 Hz to about 3,000 Hz, the measured noise power decreases with increasing frequency at a rate of approximately 6 dB per octave. For reasons of convenience detailed further below, the average power level is determined over the frequency range from about 250 Hz to about 2,500 Hz. The average power level of the example measured data of FIG. 1 is about −50 db, and is represented by the short-dashed line in the drawing. In addition, a long-dashed line is constructed to model the curve that represents the actual noise power. For this data and this particular example, the model line is selected to be a straight line with a slope of −6 dB per octave. It will be appreciated that the term “line” is not limited to a straight line, and the illustrated slope of −6 db per octave is not by way of limitation as other slopes, positive and negative, are also contemplated.

It is instructive to note that the model curve (long-dashed line) crosses the average noise level line (short-dashed line) at what will be termed the effective frequency of slightly above 700 Hz. The significance of this effective frequency is explained in more detail below, as will be the manner in which the model curve is selected and constructed.

Assuming that the model curve (long-dashed line) has been properly determined so as to relatively accurately correspond to the typical noise power frequency characteristic shape, the average power for the model curve over the selected bandwidth of about 250 Hz to about 2,500 Hz is made to be equal to the actual average noise power in the measured data by raising or lowering the model curve until the two power averages are the same. This is accomplished mathematically by solving for the magnitude of the model which makes the average model power match the actual average measured power. The effective frequency at which the model and actual average power lines cross (i.e. are equal) then can be determined. In effect, the model curve passes through the average power line such that it creates equal areas between it and the average power line, above and below the effective frequency crossing point when plotted on a magnitude squared vs. frequency plot (not shown). It can be seen that for this data the −6 dB sloped model provides a close approximation of the noise data characteristic when they cross at approximately 700 Hz. Thus, 700 Hz is determined to be the effective frequency for this data.

It should be recognized that the shape of the measured data is dependent upon the characteristics of the specific signal pickup system. With other systems, a curved (non-straight) line may be a more appropriate model for the noise response of the system. For the data depicted in FIG. 1, the measurement system was calibrated for measurement of signals in a 200 Hz to 3,400 Hz range, and outside of that range the plot should not be considered to necessarily be an accurate representation of actual ambient noise.

FIG. 2 is a plot of traffic noise measured adjacent to a street with heavy traffic. As in FIG. 1 above, the vertical axis is noise power in dB, the horizontal axis is frequency in Hz, the short-dashed line represents the average noise power over the 250 Hz to 2,500 Hz frequency band, and the long-dashed line represents the model constructed to be a straight line with a slope of −6 dB per octave. The model line (long dash) intersects the average power line (short dash) at very nearly the same effective frequency as for the restaurant noise of FIG. 1. Importantly, it will be noted traffic noise, while very different in origin, character and sound, has a spectral pattern quite similar to the restaurant noise, with the noise power decreasing with increasing frequency at approximately 6 dB per octave.

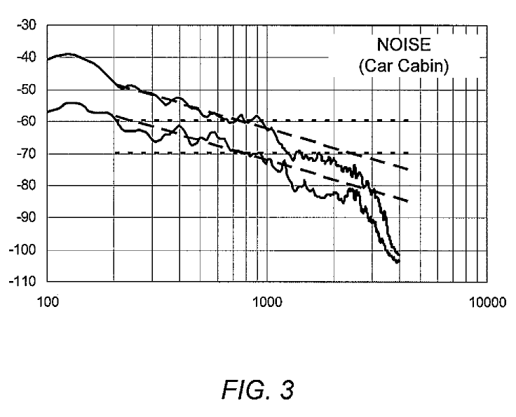

FIG. 3 shows a pair of plots of noise measured inside a car cabin, with the lower plot of measurements taken while the car was moving slowly with closed windows and no other noise source, and the higher plot of measurements taken with the car driven at 70 miles per hour, radio on and A/C fan on. The short-dashed lines and the long-dashed lines again represent the average power of the noise data, and the −6 dB sloped model line giving the corresponding average model power “curve”. Note that these model lines were made to intersect the average signal power level at the same effective frequency as determined in the FIG. 1 case. It can be seen from FIG. 3 that the spectral pattern of the noise in the car can still be described by the same −6 dB per octave model although not quite as closely as for the previous noise cases. The lines are nevertheless still quite reasonable models of the car-cabin noise.

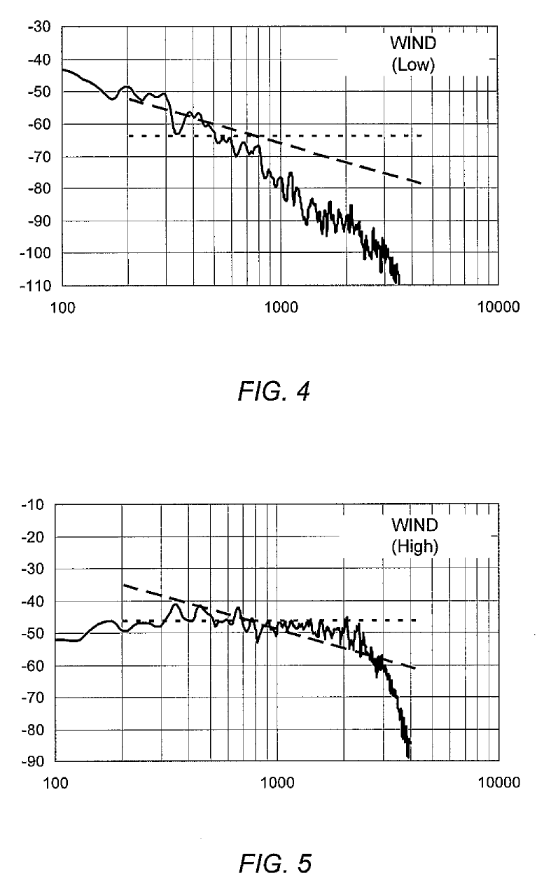

FIGS. 4 and 5 are plots of low and high wind velocity “noise,” respectively. Wind “noise” is different from other sounds in that it is the result of air turbulence at the individual microphone port(s), and only exists due to the presence of the microphone. It is noise that is induced by the wind at the microphone port(s) rather than being acoustic noise inherent in the wind and sensed by the microphone. Such wind-induced noise nevertheless results in an electrical microphone output signal commonly referred to as “wind noise.”

FIG. 4 shows data collected when the wind speed was low and subsequently did not saturate the microphones. This noise signal is characterized by relatively sustained noise bursts exhibiting both high stationarity and steeply-sloped power frequency response. FIG. 5 shows data collected in high wind speed conditions, in which the wind saturated the microphones and was extremely “bursty.” In this case, the noise signal is characterized by short, intense non-stationary bursts of signal. In intermediate wind conditions, the signal alternates between these two characteristics.

From FIGS. 4 and 5, it can be seen that wind-induced noise has characteristics that differ substantially from most common types of acoustic noise, including spectral differences and dynamic pattern differences. Further, this noise is statistically independent for each sensor signal in multi-sensor array systems. Noise suppression processes must often ignore this wind-induced noise signal, handling it separately, or differently, from the way they respond to noise of an acoustic origin. Again in FIGS. 4 and 5, a short-dashed horizontal line is drawn at the average power level, and the long-dashed noise model line with a slope of −6 dB is shown, where the model average power is matched to the measured signal power at the shown intersection frequency.

By analyzing numerous noise signals measured with the system in which the system disclosed herein may be used, it was determined that when the model curve (a straight −6 dB/oct. line in this case) was set to equal the average measured noise signal power at 750 Hz, the model did indeed create a good approximation to all acoustic noise signals. However, whereas acoustic noise signals exhibit little deviation from the model, voice (discussed below) and wind noise both exhibit significant deviation from the model. As explained above, for purposes of this discussion, three types of sound are identified: acoustic noise, wind noise, and voice. Acoustic noise is generally a catch-all for all non-wind noise and non-voice sounds.

It can be seen from the plots, that while the noise data in FIGS. 1-3 clusters closely around the model (long dash), the plots for the wind noise in FIGS. 4 and 5 do not. This difference can be used to distinguish wind noise from the other noises.

The distinction between low and high wind-induced noise is a relative concept; it can be seen that the plots are significantly different. Since wind “noise” is generated at the port(s) of the microphone, the transition wind speed between the results of FIGS. 4 and 5 will be somewhat dependent upon the physical characteristics of the microphone. However, the general relationship is applicable; that is, low wind speeds produce a steep spectral curve, whereas high wind speeds (relative to the physical configuration) produce significantly more high frequency signal, and produce a generally flat spectral response. It may be observed that the plots of FIGS. 4 and 5 are reasonably close at 200 Hz, but FIG. 5 indicates progressively more power with increasing frequency for the high wind speeds, showing substantially more power at 2,000 Hz. These curves might correspond to wind speeds of 2½ mph and 5 mph for one microphone's physical configuration, and correspond to wind speeds of 5 mph and 10 mph respectively for a microphone system with a different port design and/or built-in wind screening. However, FIGS. 4 and 5 represent the sort of variation in wind-induced noise that a specific microphone is likely to produce over a range of wind speeds.

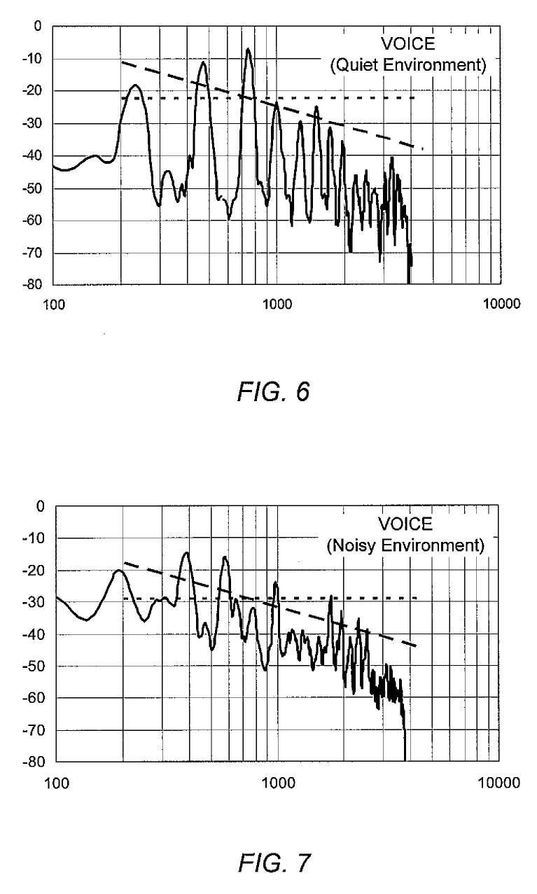

FIGS. 6 and 7 are plots of voiced speech in quiet room conditions, and voiced speech in intense noise, respectively. The noise used for the plot in FIG. 7 includes commercially recorded music mixed with voice babble from multiple directions in a diffuse-source simulation, producing approximately 85 dB SPL of noise at the microphone. The SNR of this signal was −3 dB in these conditions. This simulation was intended to approximate various conditions of crowds, such as airports, theater intermissions, retail stores, etc. As is the case in the preceding drawings, the average signal power levels (including all voice and/or noise) are represented by short-dashed horizontal lines, and the −6 dB straight line model is shown as the long-dashed lines. The graphs of FIGS. 6 and 7 show that the characteristic spectral pattern of voice, even voice with large amounts of noise included, produce substantial voice formant spectral power peaks, and therefore much larger variation in power with frequency than any of the noise conditions. This difference in spectral pattern readily distinguishes voice from noise, even in sub-zero SNR mixed input signals.

The noise activity detector (NAD) disclosed herein uses the characteristics described above to identify a signal and indicate when noise-only periods of the signal are present. There are myriad applications for such an operation—for example, it can be used to provide a control signal that gates other functions such as updating a noise template in a spectral subtraction process, updating an automatic microphone matching table, blocking an automatic gain circuit from raising the gain when only noise is present, and so on. The noise activity detector disclosed herein is described in the context of audio signals in a communication system. However, the process disclosed herein is not limited to single-channel, single-band applications, but is also applicable to multi-channel applications, as well as to multi-band applications. Since the process is performed in the frequency domain, selection of the frequency range over which it operates is simple, and additional implementations of the noise detector can be used for other frequency ranges. An example of such an application would be a multi-band spectral subtraction process in which it may be necessary to independently update the noise template for each band when there is only noise in the respective band, even though there may be voice- and/or wind-induced signal in other bands. The noise activity detector can also be used with multi-channel applications to provide an indication for each channel when its signal was only noise. Although for many multi-channel systems each input signal may be similar to the signals that the other sensors receive, there are many situations where that is not the case, such as for wind-induced noise, and noise generated mechanically at a port such as by physical contact with the operator's skin or with other objects.

As examples of possible applications, a control signal from a noise, applied to each channel of a multi-channel system, could be used for channel-specific spectral subtraction processes, and/or the signals from the noise detectors on the different channels could be combined to enable an automatic microphone matching process to compensate for variations in the sensitivities of multiple microphones. In the latter application, the channel-specific noise detectors will assure that the microphone matching does not match to noise present on a single channel.

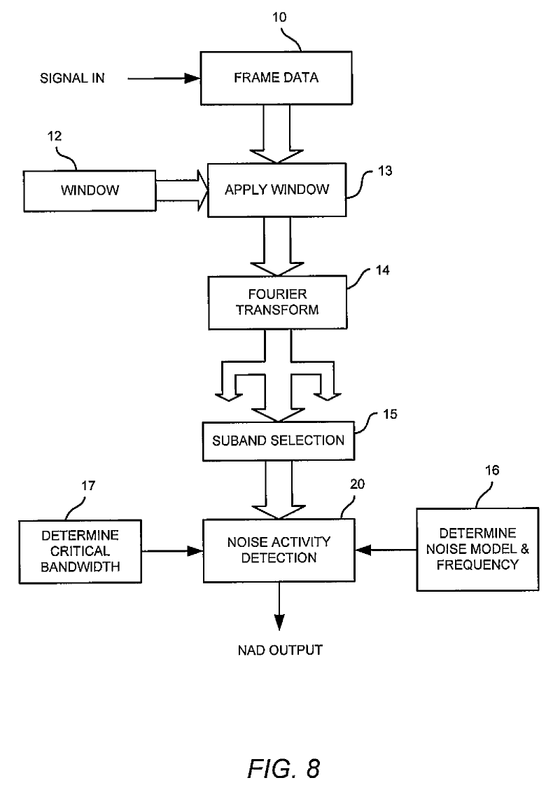

FIG. 8 is a block diagram of a typical communication system front end showing the context within which a noise activity detector (NAD) 20 may be used. The noise activity detector operates as a multi-band process so that the time domain signal is broken into multiple frequency bands. The multi-band conversion can be accomplished by use of a bank of bandpass filters (not shown) or by the application of Fourier transform processes or by any other process for such conversion. Conversion to the frequency domain is a well-known process that may use for example Short Time Fourier Transform (STFT) techniques or other well known frequency domain conversion methods. Since the systems in which NAD 20 is used are likely to employ STFT methods for other processes, such as spectral subtraction, microphone sensitivity matching and/or automatic gain control processes, the conversion step is likely to already be available, and NAD 20 would require little additional processing. The example embodiment employs the Fast Fourier Transform, and the process of NAD 20 is carried out in the frequency domain. Therefore, per the example system, the input signal can be converted to the frequency domain before the process disclosed herein is applied.

With reference to FIG. 8, the analog input signal, for example from a microphone (not shown) is framed at framing block 10. A windowing block 12 is used to create a window, which is applied by windowing application block 13 to the framed data. The framed, windowed data is converted to the frequency domain by Fourier transform block 14 (for example Fast Fourier Transform (FFT) or other appropriate transform process as explained above), and the frequency domain result can then be divided into one or, optionally, more than one sub-bands by sub-band selection block 15.

In an example embodiment, a communications audio signal with an 8 ksps (kilo-samples per second) sample rate is separated into 512-sample frames, windowed with a Hanning window, converted to the frequency domain using an FFT (Fast Fourier Transform), and a single sub-band consisting of the frequency bins between 250 Hz and 2,500 Hz is selected.

The resulting sub-band bin values are provided as input to NAD 20, the output of which is provided for subsequent control of a desired process associated with the particular communications application.

Block 16 represents the determination of the noise model and frequency process performed by the practitioner during the design of the system in which the noise detector is to be used, and is a function of the particular application. Typical noise, as sensed by the sensor system of the intended application, is analyzed for a curve fit using well known curve-fitting methods. The shape of the fitted mathematical curve is the noise model, and for example, in FIGS. 1-3, the model is a straight line shown by the declined long-dashed line. An effective frequency, F_{E}, is also determined during the design process by determining the frequency at which the modeled power equals the value of the average power.

Block 17 represents the determination of the critical bandwidth. The critical bandwidth is generally a contiguous range of frequencies that includes the range in which the data fits the model. In the signals of FIGS. 1-3, it can be seen that data for the system that was measured fits the straight line model over a frequency range from about 200 Hz to somewhere between 2,500 Hz and 3,000 Hz. As an example, a frequency range of 250 Hz to 2,500 Hz can be selected. A small adjustment to the selected frequency range in order to provide a convenient number of FFT bins will not significantly impact the performance of the noise detector. In the exemplary embodiment the bandwidth utilized for the noise activity detector comprised 128 FFT bins, which, as an even power of two, is a convenient divisor for calculating the average power in the 128 bins.

The critical bandwidth, noise power model and effective frequency determination processes of blocks 16 and 17 may use the following steps:
Examine the power spectrum of the input signal under typical input noise conditions. Select the sub-band (block 15) to be used such that it includes only valid information for the task. For example, in a single-channel voice grade communication system, a sub-band extending from 250 Hz to 3000 Hz is applicable. Sub-band bandwidths and the number of sub-bands to be used for other systems can be readily determined.
Select a model and model complexity (block 16) for each sub-band (they need not be the same for each sub-band). Polynomial curve fitting can be used for this step, or any other common curve fitting method is applicable. A monotonic function is preferred. For the example embodiment described above, the model uses a first-order curve (straight line) with two parameters: slope and intercept.
Determine the parameter values from the typical noise-only data. In the example implementation, the slope is determined from the frequency response data, and the intercept is determined by the average energy.
Calculate the effective frequency—that is, the frequency at which the value of the model power curve equals the average signal power contained in the sub-band portion of the actual measured noise signal. As shown in FIGS. 1-3, this is the frequency at which the short dashed line crosses the long dashed model line on the graphs—that is, 746 Hz. Of course this 746 Hz value is specific only to the example described herein, and other applications will have a different effective frequency.

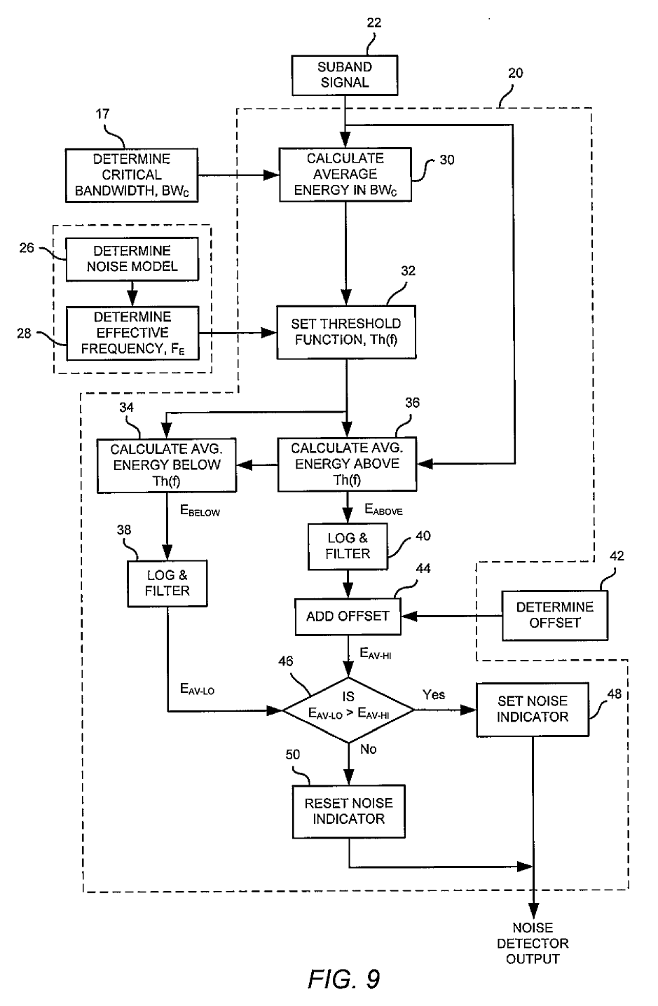

The process of block 16 is described in more detail with reference to FIG. 9, which is generally a flow diagram depicting the operation of noise activity detector (NAD) 20. The input signal is sub-band signal 22, which is the output signal provided by sub-band selection process 15 of FIG. 8, and is used to calculate average energy in the critical bandwidth step 30.

Noise model determination is performed at step 26, together with a determination of the effective frequency at step 28. Steps 26 and 28 correspond to block 16 of FIG. 8. As previously mentioned, noise model determination can be made based on visual observation, or determined more rigorously with known curve fitting algorithms. As such, it can be determined how well any particular power curve model will represent the measured signal power data. In the case of the data of FIGS. 1-3, it can be seen that a straight line with a slope of approximately −6 dB per octave will model, reasonably well, the sensor system response for all the noise source data depicted in these plots, and the noise power measured through the microphone system substantially fits a straight line model over a frequency range from about 200 Hz to 2,500 Hz. Thus, determination of critical bandwidth (step 17) may use this bandwidth for a single channel system or may use multiple critical sub-bands for a multiple channel system. A different microphone design would produce different results, and could require a curved line model instead of a straight line model for the noise signal. Rigorous methods of curve fitting can be used to provide a precise model, but doing so is generally not required to achieve the desired result, and the more complex the model, the more processing power will be required in operating the noise detector.

The determination of effective frequency F_{E} (step 28) is also accomplished as mentioned above and described here more fully. After the shape of the noise power model 26 and the critical bandwidth 17 have been determined, the power model is mathematically integrated over the critical bandwidth to determine the average model power level. The frequency at which this level intersects the noise power model curve is the effective frequency F_{E}.

Let the noise power model be defined as

P_{NM}(f)=α·S_{N}(f) (1)

where P_{NM}(f) is the noise power model, S_{N}(f) is the noise power model shape function, f is frequency, and α is a magnitude scale factor to be determined. The shape model is integrated over the critical bandwidth and then divided by the critical bandwidth, BW_{C}, to produce the average noise power model level.

Let the critical bandwidth of the sub-band be defined by its lower frequency boundary, f_{low}, and its upper frequency boundary, fₕᵢ. In the exemplary case being discussed here, f_{low}=200 and fₕᵢ=2500. Therefore

BW_{C}=fₕᵢ−f_{low} (2)

and, the average noise power model level is

$${P}_{NM avg} = \frac{1}{{BW}_{C}} {\int }_{{f}_{low}}^{{f}_{hi}} {P}_{NM} ( f ) \cdot d f \qquad ( 3 )$$

This average noise model power level will equal the value of the noise power model at the effective frequency F_{E}. That is,

P_{NM avg}=P_{NM}(F_{E}) (4)

therefore, F_{E} can be found by solving equation 4. As can be readily seen, model curves that are monotonic are preferred.

For the example case,

$$\begin{matrix}{P}_{NM} ( f ) = a \cdot {f}^{- 2} \\ and & ( 5 ) \\ {F}_{E} = {\frac{1}{a} [ \frac{1}{2300} {\int }_{200}^{2500} a \cdot {f}^{- 2} \cdot d f ]}^{- \frac{1}{2}} = 707 Hz & ( 6 )\end{matrix}$$

which is effectively about 700 Hz.

The above parameters of critical bandwidth, noise power model and effective frequency can all be predetermined during the design of the noise detector, and need not be calculated in real-time, thereby reducing the calculation power required for the operating system.

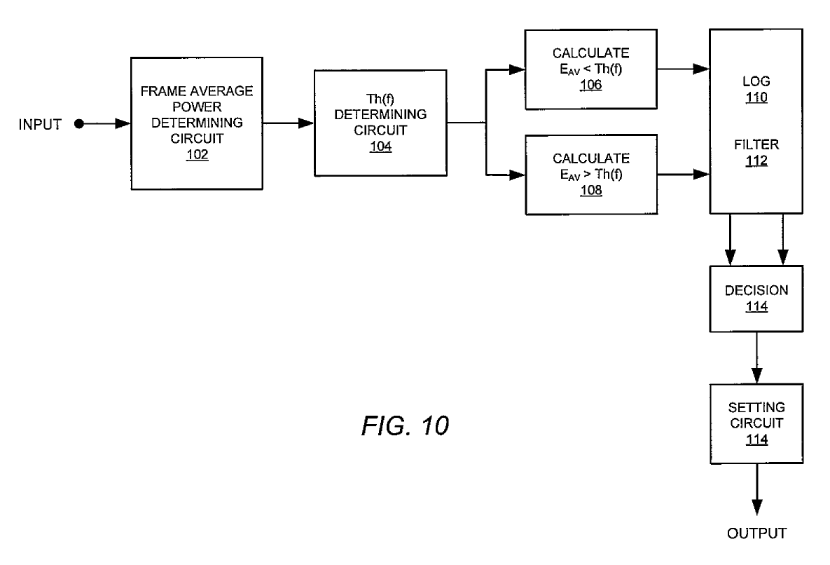

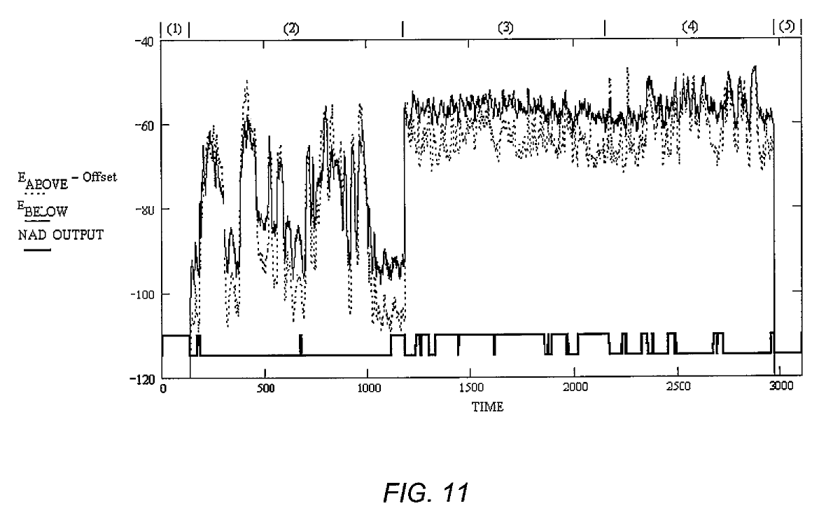

The real time operation of the noise activity detector (NAD) 20 is now described with reference to FIG. 9, which shows a flow diagram of various steps or tasks that are performed. It will be appreciated that these tasks can each be performed by a dedicated circuit, as shown in FIG. 10, or one or more circuits can be used to perform any one or more of the tasks. Additionally, it may be possible to use a single processor, or several processors, to perform the tasks, each processor having one or more modules that may be dedicated to one or more tasks.

At step 30 in FIG. 9, average energy in BW_{C} is calculated, and the power across the entire critical bandwidth for the selected sub-band is summed and divided by the critical bandwidth, BW_{C}, to generate a value for the signal's average power level of the current frame. Circuit 102 of FIG. 10 is provided for this task. This average power level value is used at step 32 of FIG. 9 to define a threshold function Th(f) that is unique to the current frame of data. Circuit 104 of FIG. 10 is provided for this purpose.

The define threshold function, Th(f), step 32 (and circuit 104) determines a dynamic frequency-dependent threshold using the noise power model, P_{NM}(f), determined in step 26 and the effective frequency, F_{E}, determined in step 28, by calculating the average power in the current frame of data and setting the level, α, of the model so that the average power level for the current frame is equal to the value of the model at the effective frequency, F_{E} That is,

$$a = \frac{{P}_{N avg}}{{S}_{N} ( {F}_{E} )} \qquad ( 7 )$$

where P_{N avg} is the current average power level. Thus, the threshold function for the ith frame of data is determined by circuit 104 and in step 32 as

Thᵢ(f)=aᵢ·S_{N}(f)=P_{NM i}(f) (8)

Note that this threshold is not a single level and is not dependent upon prior frames of data, both of which are common in other such detectors. Because the threshold is immediate—that is, calculated for and used by only the current frame—the NAD 20 is able to follow rapid changes in background noise. Thus a dynamic modification of the frequency-dependent threshold function using the average energy is used.

The threshold function, Thᵢ(f), is used to divide the spectral data of the current frame into two groups, those FFT frequency bins whose power data magnitudes are greater than the threshold, and those whose power data magnitudes are less than the threshold. FIGS. 4-7, depicting wind noise and voice characteristics, all represent data that, when applied to the example embodiment of noise activity detector 20, generate threshold functions as shown by the long-dashed lines of each respective plot. Every FFT bin holds a complex value having a magnitude which corresponds to the average magnitude of the signal content in the frequency bandwidth of the FFT bin over the time period of one frame. In the Calculate Average Energy In BW_{C} step 30, the magnitude in each FFT bin is squared and the squared values are averaged, thus providing the average energy per bin over the time period of the frame. As described above, step 32 (circuit 104) uses this value to determine the value of αᵢ and therefore the threshold function Thᵢ(f) for the current frame, where i is the frame index. A Calculate Average Energy Below Th(f) step 34 is performed by circuit 106, which sums the squares of the magnitudes corresponding to bins with magnitudes less than the threshold, and divides that sum by the number of bins with magnitudes less than the threshold, resulting in an average energy per bin for the bins with magnitudes less than the threshold. In addition, a Calculate Average Energy Above Th(f) step 36 is performed by circuit 108, which sums the squares of the magnitudes corresponding to bins with magnitudes greater than the threshold, and divides that sum by the number of bins with magnitudes greater than the threshold, resulting in an average energy per bin for the bins with magnitudes greater than the threshold. Step 34 provides the signal E_{BELOW} while step 36 provides the signal E_{ABOVE}.

The logarithms of the energy averages E_{BELOW} and E_{ABOVE} are each calculated in steps 38 and 40, and the resulting values optionally provided to filters that create a smoothing function across time by acting on the values from sequential frames. Log circuit 110 and filtering circuit 112 of FIG. 10 provide these functions. Although the smoothing is not required for proper operation of the noise detector of this application, such filtering can be used to create longer hangover times, if desired. However, because the detector is able to correctly determine the presence of voice even when the voice power is well below the noise power in the incoming signal, additional hangover is often superfluous.

When desired, the filtering of steps 38 and 40 in an exemplary embodiment is performed with an exponential filter of the following form:

E_{X avg}=αₓ·(log(E_{Y i})−log(E_{X i-1}))+log(E_{X i-1}) (9)

where E_{Y} is either E_{BELOW} or E_{ABOVE}, α_{X} is a time constant that determines the amount of smoothing where α_{X} is between 0 and 1, and where a typical value may be 0.1. The subscript x denotes that α_{X} may have different values for the ABOVE and BELOW cases. E_{Y} is the smoothed output signal, where Y can be ABV or BLW, designating which signal is being smoothed.

There is no limitation on the type and complexity of the smoothing filter(s), and many are known in the art. More complex smoothing filters can be used which can provide asymmetrical rise (attack) and fall (decay) time constants. Hangover is created when the ABOVE smoothed signal is able to move up faster than down, and the BELOW smoothed signal is able to move down faster than up.

The approach described above provides two signals that are similar in magnitude for a typical noise signal input to noise detector 20 so detection of the noise only portion of the input signal is simplified if one of these signals is offset from the other. During system design, an offset is determined by the practitioner in Determine Offset step 42, where the offset is slightly larger than the random variation in the two logarithmic signals when a noise signal is input to noise detector 20. This amount of offset then prevents false negative triggers of the noise detector, i.e. false indications that other-than-noise is present when indeed the input signal is only noise. Such false triggers do not create error in operation of the associated noise reduction or other process with which the noise detector is used, but it does slow the operation of some. The offset, therefore is meant to minimize this effect. The offset, which may be a negative number, is added to the output of log & filter step 40 in add offset step 44. Just as well, the add offset step could be after step 38 and the offset applied to the signal E_{AV-LO}. In this case, in order to achieve the same result, the offset value determined in step 42 would have the opposite sign.

After offsetting one of the two signals, the resulting values are compared in the decision step 46 (circuit 114). Decision step 46 causes Set Noise Indicator step 48 (circuit 116) to set the NAD output to an “on” state indicating the presence of noise only if the output from step 38, E_{AV-LO}, is greater than the output from step 44, E_{AV-HI}. When E_{AV-LO} is less than E_{AV-HI}, decision test step 46 causes reset noise indicator step 50 to reset NAD output to an “off” state indicating the presence of other-than-noise in the input signal. An alternate embodiment uses an offset value dependent upon whether the NAD output is currently on or off, and in this way hysteresis can be incorporated into the NAD switching for applications where it is desirable to have a more stable NAD output.

To illustrate the performance of this noise detector, FIG. 11 is a plot of the non-smoothed E_{ABOVE}+Offset signal, the E_{BELOW} signal and the noise activity detector output signal. The horizontal scale is shown as time in frames, and the vertical scale is in dB for the E_{ABOVE}+Offset and E_{BELOW} signals. In this plot, the NAD output signal is high when noise-only conditions are detected and low when non-noise is found. The scale for the NAD output is arbitrary, since it represents an on/off binary flag.

Across the top are numbered sections indicating the input signal characteristics at different times. Sections (1) and (5) are periods of time with only silence and when noise detector 20 had no signal input. In this case, whichever state the noise detector indicates is acceptable since the input signal is neither noise nor non-noise, and a noise reduction system would have no input noise to reduce.

Section (2) is a period during which the signal input to the noise detector 20 was clean voice in quiet ambient conditions. A short period at the end of this second section has only normal room ambient sound with no voice. The noise detector properly handled this relatively easy condition, indicating the presence of the voice as non-noise and yet detecting the absence of voice during noise only periods. The system used for the plot of FIG. 11 included smoothing filters to provide additional hangover by design so there is a short time after the cessation of voice bursts when the detector's output does not change indication.

Section (3) consists of very loud (85 dB SPL) input noise only sound that was a mixture of music, single loud voice and voice babble from multiple directions. Here it can be seen that the noise detector indicates mostly noise only, but also creates non-noise indications as a result of the single loud background voice even though the SNR for the background voice is less than −10 dB.

In section (4) nearby voice speech was added to the noise from Section (3), with the added voice SNR being approximately −3 dB. As designed, the NAD output shows that the noise-only periods are correctly indicated while during voicing, the NAD correctly indicates non-noise. Correct operation at such low input SNR levels shows the capability of this new noise/voice detector.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A method for generating an indication of noise activity in a signal, comprising:
a) calculating average energy of the signal in a critical bandwidth;
b) determining a frequency-dependent threshold function;
c) generating a dynamic modification of the frequency-dependent threshold function using the average energy;
d) identifying frequency components of the signal having energy that is above threshold values determined by the threshold function at corresponding frequencies, and determining a first average energy value representing an average energy of the identified frequency components with energy above the threshold values;
e) identifying frequency components of the signal having energy that is below threshold values determined by the threshold function at corresponding frequencies, and determining a second average energy value representing an average energy of the identified frequency components with energy below the threshold values;
f) applying an offset value to at least one of the first and second average energy values;
g) comparing, after application of said offset value, the resultant first and second average energy values with one another, and
h) indicating the presence of noise activity if, as a result of said comparison, it is determined that, the resultant first average energy value is below the resultant second average energy value.

2. The method of claim 1, wherein procedures a)-h) are carried out over individual frames of a multi-frame process.

3. The method of claim 1, further comprising filtering prior to the comparison at g).

4. The method of claim 3, wherein the filtering is conducted using an exponential filter.

5. The method of claim 3, wherein filtering with asymmetrical rise and fall time constants is applied to the signals representing average energy of the identified frequency components with energy above the threshold and the average energy of the identified frequency components with energy below the threshold.

6. A noise activity detector for generating an indication of noise activity in a signal comprising:
a) a first circuit configured to calculate the average energy in a critical bandwidth;
b) a second circuit configured to determine a frequency-dependent threshold function;
c) a third circuit configured to generate a dynamic modification of the frequency-dependent threshold function using the average energy;
d) a fourth circuit configured to identify frequency components of the signal having energy that is above threshold values determined by the threshold function at corresponding frequencies, and to determine a first average energy value representing an average energy of the identified frequency components with energy above the threshold;
e) a fifth circuit configured to identify frequency components of the signal having energy that is below threshold values determined by the threshold function at corresponding frequencies, and to determine a second average energy value representing an average energy of the identified frequency components with energy below the threshold;
f) a sixth circuit configured to apply an offset value to at least one of the first and second average energy values;
g) a seventh circuit configured to compare, after application of said offset value, the resultant first and second average energy values with one another; and
h) an eight circuit configured to indicate the presence of noise activity if, as a result of said comparison, it is determined that the resultant first average energy value is below the resultant second average energy value.

7. The detector of claim 6, wherein the circuits carry out their function over individual frames of a multi-frame process.

8. The detector of claim 6, further comprising a circuit for introducing an offset prior to the comparisons by the seventh circuit.

9. The detector of claim 6, further comprising a filter for filtering prior to comparison.

10. The detector of claim 9, wherein the filter is an exponential filter.

11. The detector of claim 9, wherein the filter includes at least one filter incorporating asymmetric rise and fall time constants.

12. A noise activity detector for generating an indication of noise activity in a signal, comprising:
a) means for calculating average energy of the signal in a critical bandwidth;
b) means for determining a frequency-dependent threshold function;
c) means for generating a dynamic modification of the frequency-dependent threshold function using the average energy;
d) means for identifying frequency components of the signal having energy that is above threshold values determined by the threshold function at corresponding frequencies, and determining a first average energy value representing an average energy of the identified frequency components with energy above the threshold values;
e) means for identifying frequency components of the signal having energy that is below threshold values determined by the threshold function at corresponding frequencies, and determining a second average energy value representing an average energy of the identified frequency components with energy below the threshold values;
f) means for applying an offset value to at least one of the first and second average energy values;
g) means for comparing, after application of said offset value, the resultant first and second average energy values with one another, and
h) means for indicating the presence of noise activity if, as a result of said comparison, it is determined that, the resultant first average energy value is below the resultant second average energy value.

13. The noise activity detector of claim 12, wherein procedures a)-h) are carried out over individual frames of a multi-frame process.

14. The noise activity detector of claim 12, further comprising filtering prior to the comparison at g).

15. The noise activity detector of claim 14, wherein the filtering is conducted using an exponential filter.

16. The noise activity detector of claim 14, wherein filtering with asymmetrical rise and fall time constants is applied to the signals representing average energy of the identified frequency components with energy above the threshold and the average energy of the identified frequency components with energy below the threshold.

17. A program storage device readable by a machine, embodying a program of instructions executable by the machine to perform a method for generating an indication of noise activity in a signal, the method comprising:
a) calculating average energy of the signal in a critical bandwidth;
b) determining a frequency-dependent threshold function;
c) generating a dynamic modification of the frequency-dependent threshold function using the average energy;
d) identifying frequency components of the signal having energy that is above threshold values determined by the threshold function at corresponding frequencies, and determining a first average energy value representing an average energy of the identified frequency components with energy above the threshold values;
e) identifying frequency components of the signal having energy that is below threshold values determined by the threshold function at corresponding frequencies, and determining a second average energy value representing an average energy of the identified frequency components with energy below the threshold values;
f) applying an offset value to at least one of the first and second average energy values;
g) comparing, after application of said offset value, the resultant first and second average energy values with one another, and
h) indicating the presence of noise activity if, as a result of said comparison, it is determined that, the resultant first average energy value is below the resultant second average energy value.

18. The device of claim 17, wherein procedures a)-h) are carried out over individual frames of a multi-frame process.

19. The device of claim 17, further comprising filtering prior to the comparison at g).

20. The device of claim 20, wherein the filtering is conducted using an exponential filter.

21. The device of claim 20, wherein filtering with asymmetrical rise and fall time constants is applied to the signals representing average energy of the identified frequency components with energy above the threshold and the average energy of the identified frequency components with energy below the threshold.
